(19) United States
(12) Patent Application Publication
(10) Pub. No.: US 2009/0065342 A1
(43) Pub. Date: Mar. 12, 2009

(54) Dome switch, method of manufacturing the same, and keypad assembly having the same

(75) Inventors: Hak-Young Yoon, Seoul (KR); Shin-Woo Ok, Suwon-si (KR)

Correspondence Address: DOCKET CLERK, P.O. DRAWER 800889, DALLAS, TX, 75380, US

(73) Assignee: Samsung Electronics Co. Ltd., Suwon-si (KR)

(21) Appl. No.: 12/221,879

(22) Filed: Aug. 7, 2008

(30) Foreign Application Priority Data
Sep. 10, 2007 (KR) 2007-0091580

(51) Int. Cl. H01H 13/70; H01H 5/18; H01H 11/00

(52) U.S. Cl. 200/5 A; 200/406; 29/622

(57) ABSTRACT

Provided is a dome switch including soldering pads formed at an upper surface of a circuit board and spaced a certain distance from one another, and a dome switch fixed to the soldering pads at two ends of the dome switch. Since the dome switch is directly fixed to the circuit board, even if a degree of fatigue of the dome switch increases due to long term use thereof, it is possible to prevent deformation of the dome switch, thereby increasing the reliability of products.

### CROSS-REFERENCE TO RELATED APPLICATION(S) AND CLAIM OF PRIORITY

The present application claims the benefit under 35 U.S.C §119(a) from an application entitled “DOME SWITCH, METHOD OF MANUFACTURING THE SAME, AND KEYPAD ASSEMBLY HAVING THE SAME” filed on Sep. 10, 2007 and assigned Serial No. 2007-0091580, the entire contents if which are hereby incorporated herein by reference.

### TECHNICAL FIELD OF THE INVENTION

The present invention relates to a dome switch and, more particularly, to a dome switch capable of preventing deformation and separation of a dome switch due to long term use by directly fixing the dome switch to a circuit board without a dome sheet, a method of manufacturing the same, and a keypad assembly having the same.

### BACKGROUND OF THE INVENTION

In general, a mobile terminal includes a display assembly and a keypad assembly. The keypad assembly includes a key plate, a printed circuit board, and a case for accommodating the key plate and the printed circuit board.

Keys installed at the key plate, which are clicked by a user, have numbers or characters printed thereon. The printed circuit board generates a predetermined electrical signal as the key is clicked, and thus, a number or a character corresponding to the electrical signal is displayed through a display.

In keeping with the slimming and miniaturization of communication appliances, the dome switch includes a metal dome switch disposed on the circuit board to perform an ON/OFF contact with a circuit, and a key sheet mounted on the dome switch.

FIG. 1 is an exploded perspective view of a conventional keypad assembly, and FIGS. 2 and 3 are longitudinal cross-sectional views showing deformation of a conventional dome switch.

Referring to FIGS. 1 to 3, in the conventional keypad assembly, an oval dome switch 20 formed of a conductive metal is disposed on a circuit board 10, and a dome sheet 30 is disposed on the oval dome switch 20.

The dome switch 20 is mounted on the circuit board 10, and in this state, as a user pushes the dome sheet 30, a center portion of the dome switch 20 is lowered to be in contact with a fixed contact 11 of the circuit board 10 to perform a function of a key switch.

A lower case 40 is disposed under the circuit board 10, and an upper case 50 and a key plate 60 are disposed on the dome sheet 30.

However, in the conventional dome switch, the dome switch 20 is simply disposed under the dome sheet 30 and is not fixed to the dome sheet 30. When a degree of fatigue of the dome switch 20 increases due to long term use thereof, the tension of the dome switch 20 is weakened, and both ends of the dome switch 20 are separated from contact with the circuit board 10. As a result, the keys of the key plate 60 cannot be pushed. Further, these problems may occur more frequently due to an abrupt increase in the use of the keys as the function of the mobile communication terminal increases.

### SUMMARY OF THE INVENTION

To address the above-discussed deficiencies of the prior art, it is a primary object of the present invention to provide a dome switch capable of effectively preventing deformation and separation of the dome switch to increase the reliability of products by simply and securely fixing both ends of the dome switch to a circuit board using a fixing means such as soldering without a dome sheet, a method of manufacturing the same, and a keypad assembly having the same.

The foregoing and/or other objects of the present invention may be achieved by providing a dome switch, a method of manufacturing the same, and a keypad assembly having the same.

First, according to one aspect of the present invention, a dome switch may have a structure capable of securely fixing a dome switch to a circuit board through soldering, without a dome sheet.

The dome switch in accordance with the present invention includes soldering pads formed at an upper surface of a circuit board and spaced a certain distance from one another, and a dome switch fixed to the soldering pads at two ends of the dome switch. The soldering pad may have an “I” shape or a “T” shape. The soldering pad may be formed into an appropriate shape depending on the design conditions.

The soldering pads may include four pads disposed on the upper surface of the circuit board to be opposite to one another in lateral and longitudinal directions, and the soldering pads may be integrally formed with one another.

A method of manufacturing a dome switch in accordance with the present invention includes: soldering a contact of a circuit board to form soldering pads; mounting a dome switch on the circuit board; and applying heat to the dome switch to fix two ends of the dome switch to the soldering pads.

In soldering a contact of a circuit board to form soldering pads, a solder mask may be used. The solder mask may function to coat an unchangeable element having durability in physical and chemical environments to protect the circuit board and prevent generation of a solder bridge.

A keypad assembly in accordance with the present invention includes: a lower case; a circuit board disposed on the lower case; soldering pads formed at an upper surface of the circuit board and spaced a certain distance from one another; a dome switch fixed to the soldering pads by soldering two ends of the dome switch; and an upper case coupled to the lower case.

Meanwhile, a dome switch according to another aspect of the present invention may have a structure capable of securely fixing a dome switch to a circuit board using locking projections and locking grooves without a dome sheet.

The dome switch in accordance with the present invention includes: locking grooves formed at an upper surface of a circuit board and spaced a certain distance from one another; and a dome switch having locking projections formed at two ends of the dome switch with the locking projection inserted into the locking grooves.

A method of manufacturing a dome switch in accordance with the present invention includes: forming locking grooves at an upper surface of a circuit board; and inserting locking projections formed at two ends of the dome switch into the locking grooves to fix the dome switch to the circuit board.

A keypad assembly in accordance with the present invention includes: a lower case; a circuit board disposed on the lower case; locking grooves formed at an upper surface of the circuit board and spaced a certain distance from one another; a dome switch having locking projections formed at two ends of the dome switch with the locking projections inserted into the locking grooves; and an upper case coupled to the lower case.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an exploded perspective view of a conventional keypad assembly;

FIGS. 2 and 3 are longitudinal cross-sectional views showing deformation of a conventional dome switch;

FIG. 4 is an exploded perspective view of a keypad assembly in accordance with an exemplary embodiment of the present invention;

FIG. 5 is an exploded perspective view of a dome switch of FIG. 4;

FIG. 6 is a longitudinal cross-sectional view of the dome switch of FIG. 4;

FIG. 7 is a flowchart showing a method of manufacturing a dome switch in accordance with an exemplary embodiment of the present invention;

FIG. 8 is an exploded perspective view showing a first modification of a soldering pad;

FIG. 9 is an exploded perspective view showing a second modification of a soldering pad;

FIG. 10 is an exploded perspective view showing a third modification of a soldering pad;

FIG. 11 is an exploded perspective view of a keypad assembly in accordance with another exemplary embodiment of the present invention;

FIG. 12 is an exploded perspective view of a dome switch of FIG. 11;

FIG. 13 is a longitudinal cross-sectional view of the dome switch of FIG. 11; and

FIG. 14 is a flowchart showing a method of manufacturing a dome switch in accordance with another exemplary embodiment of the present invention.

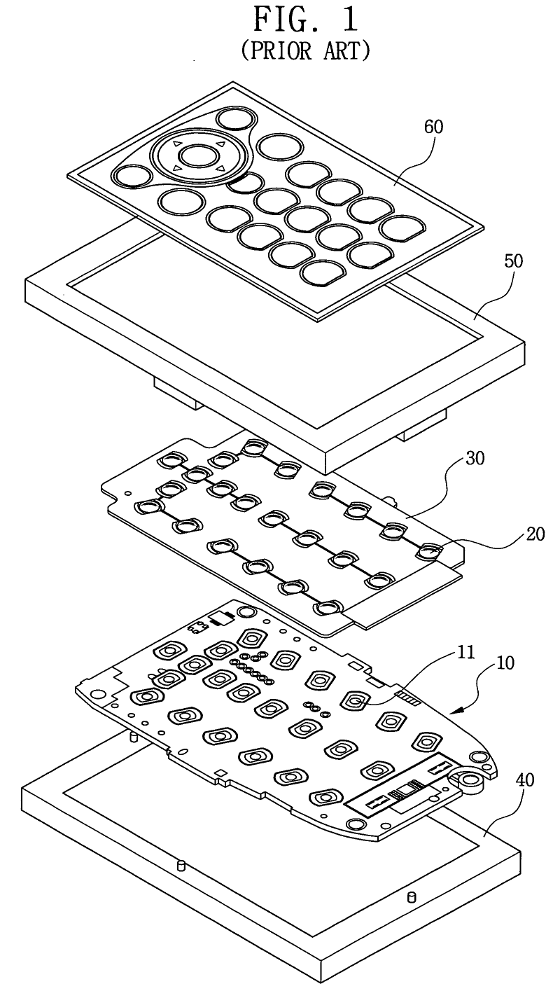

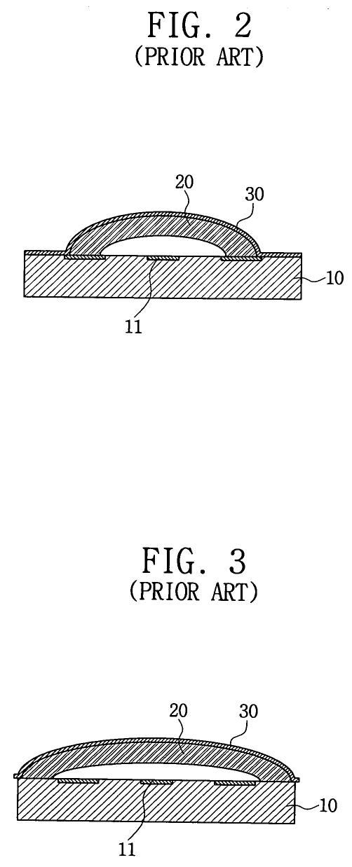

### DETAILED DESCRIPTION OF THE INVENTION

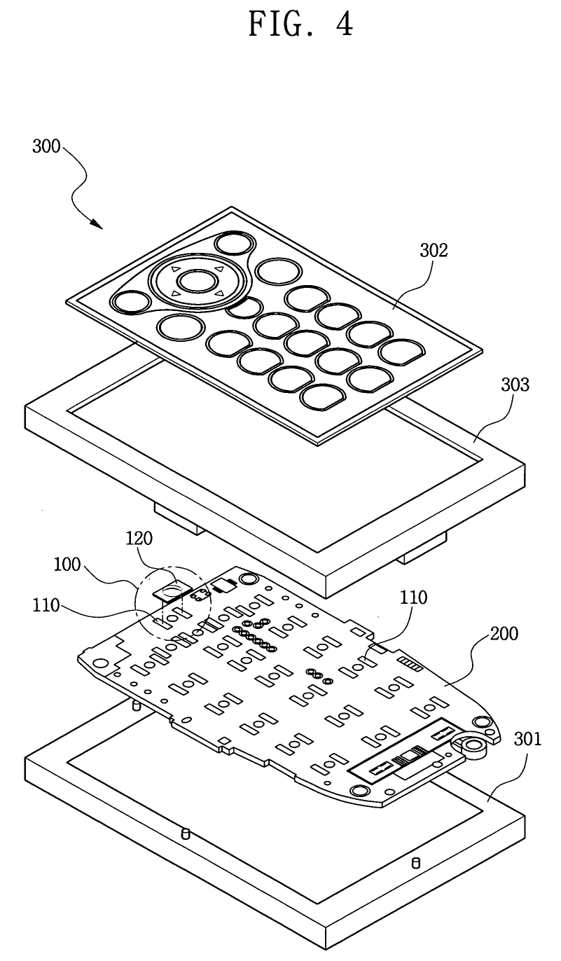

FIGS. 4 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile terminal.

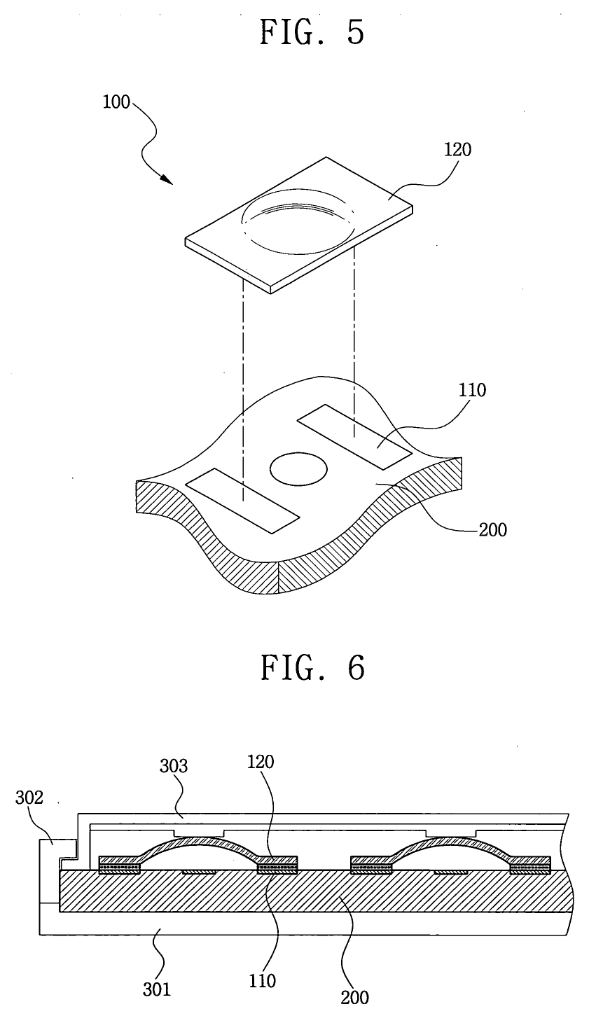

FIG. 4 is an exploded perspective view of a keypad assembly in accordance with an exemplary embodiment of the present invention, FIG. 5 is an exploded perspective view of a dome switch of FIG. 4, and FIG. 6 is a longitudinal cross-sectional view of the dome switch of FIG. 4.

Referring to FIGS. 4 to 6, a dome switch 100 in accordance with an exemplary embodiment of the present invention includes soldering pads 110 formed at an upper surface of a circuit board 200 and spaced a certain distance from one another, and a dome switch 120 fixed to the soldering pads 110 by soldering both ends thereof.

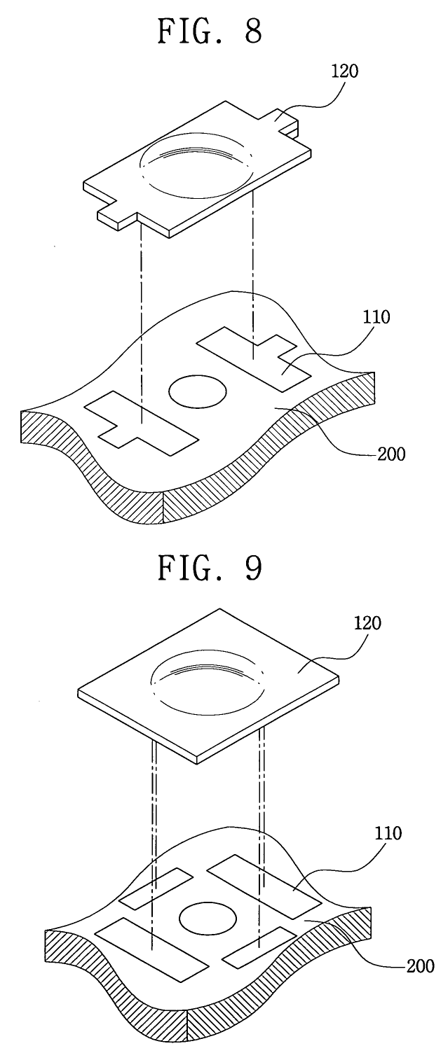

Each of the soldering pads 110 may have an “I” shape shown in FIG. 5 or a “T” shape shown in FIG. 8.

Since the T-shaped soldering pad 110 of FIG. 8 has a larger contact area between the soldering pad 110 and the circuit board 200 than the I-shaped soldering pad 110 of FIG. 5, the dome switch 120 of FIG. 8 can be more securely fixed to the upper surface of the circuit board 200.

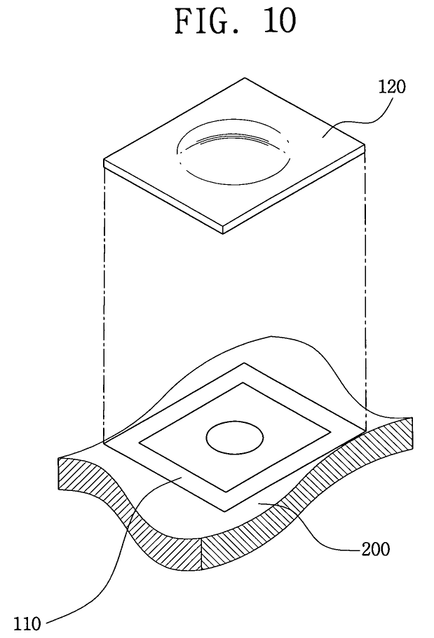

In addition, as shown in FIG. 9, the soldering pads 110 may include four pads disposed at the upper surface of the circuit board to be opposite to one another in lateral and longitudinal directions, or as shown in FIG. 10, four pads may be integrally formed with one another.

The shapes of the soldering pads 110 are shown for the illustrative purpose only, and thus, the soldering pads 110 may be appropriately formed depending on design conditions.

In addition, a keypad assembly 300 including a dome switch in accordance with an exemplary embodiment of the present invention includes a lower case 301, a circuit board 200 mounted on the lower case 301, soldering pads 110 formed at an upper surface of the circuit board 200 and spaced a certain distance from one another, a dome switch 120 fixed to the soldering pads 110 by soldering both ends thereof, a key plate 302 mounted on the dome switch 120, and an upper case 303 coupled to the lower case 301.

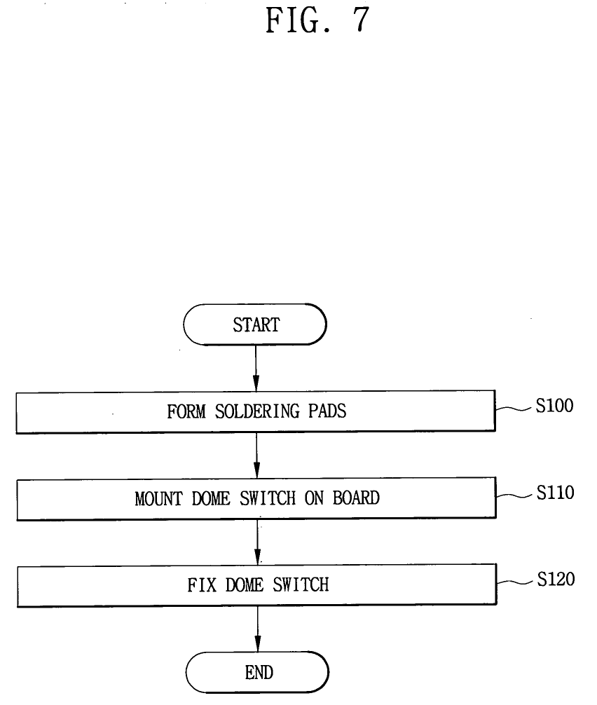

FIG. 7 is a flowchart showing a method of manufacturing a dome switch in accordance with an exemplary embodiment of the present invention.

Hereinafter, a method of manufacturing a dome switch in accordance with an exemplary embodiment of the present invention will be described with reference to FIG. 7.

As shown in FIG. 7, in the method of manufacturing a dome switch in accordance with an exemplary embodiment of the present invention, soldering pads are formed at fixed contacts which are disposed at an outer side, among a plurality of fixed contacts formed at a circuit board, by soldering using a solder mask (S100).

Next, a dome switch is mounted on the circuit board by a conveyance robot of a conveyance apparatus. At this time, both ends of the dome switch are aligned with the soldering pads (S110).

Heat is then applied to the dome switch to melt the soldering portions so that both ends of the dome switch are fixed to the soldering pads (S120).

As described above, since the dome switch 120 of the present invention is fixed to the circuit board 200 by soldering using the soldering pads 110, even if a degree of fatigue of the dome switch 120 increases due to long term use thereof, it is possible to prevent deformation of the dome switch 120, thereby increasing the reliability of products.

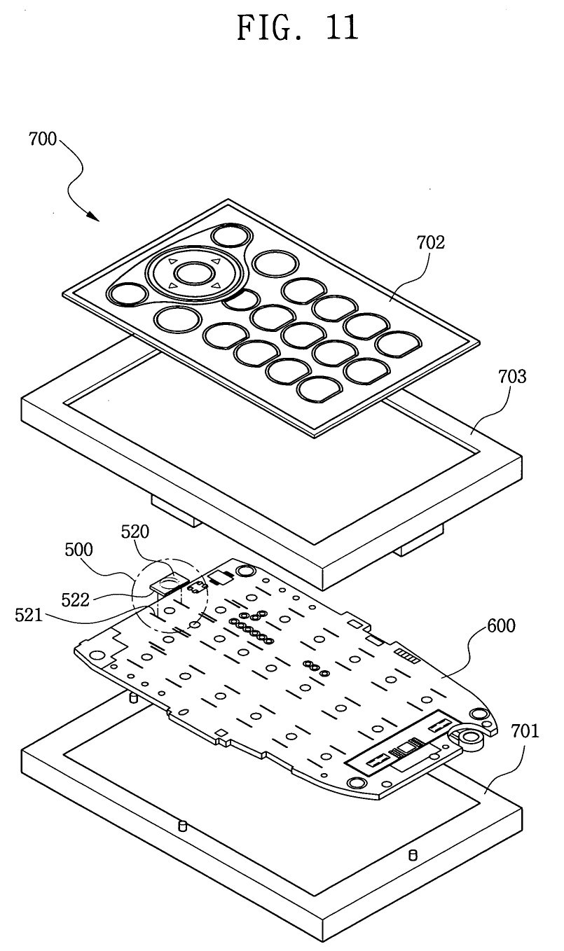

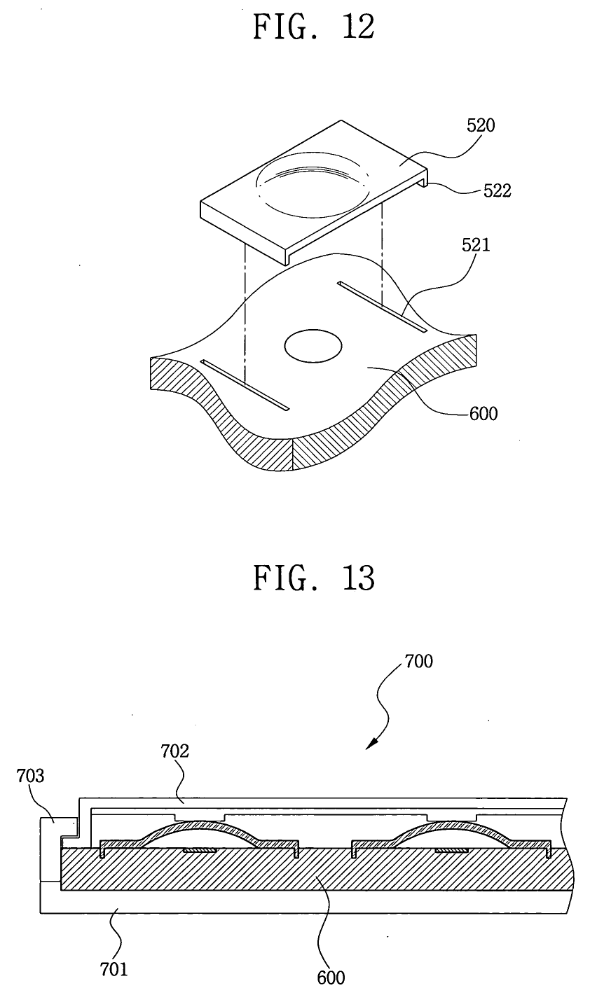

FIG. 11 is an exploded perspective view of a keypad assembly in accordance with another exemplary embodiment of the present invention, FIG. 12 is an exploded perspective view of a dome switch of FIG. 11, and FIG. 13 is a longitudinal cross-sectional view of the dome switch of FIG. 11.

As shown, a dome switch 500 in accordance with another exemplary embodiment of the present invention employs a structure in which locking projections 522 are inserted into locking grooves 521 to fix a dome switch 520 to an upper surface of a circuit board 600. The locking grooves 521 are formed at the upper surface of the circuit board 600 and spaced a certain distance from one another, and the locking projections 522 are formed at both ends of the dome switch 520 to be inserted into the locking grooves 521.

In addition, a keypad assembly 700 in accordance with another embodiment of the present invention includes a lower case 701, a circuit board 600 disposed on the lower case 701, locking grooves 521 formed in an upper surface of the circuit board 600 and spaced a certain distance from one another; locking projections 522 formed at both ends of a dome switch 520 to be inserted into the locking grooves 521, a key plate 702 installed on the dome switch 520, and an upper case 703 coupled to the lower case 701.

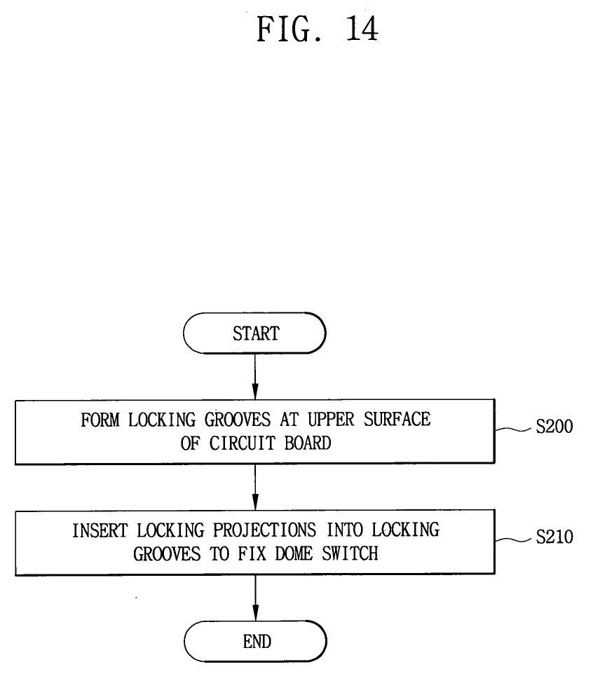

FIG. 14 is a flowchart showing a method of manufacturing a dome switch in accordance with another exemplary embodiment of the present invention. Hereinafter, a method of manufacturing a dome switch in accordance with another exemplary embodiment of the present invention will be described with reference to FIG. 14.

As shown in FIG. 14, a method of manufacturing a dome switch in accordance with another embodiment of the present invention includes forming locking grooves at an upper surface of a circuit board (S200), and inserting locking projections formed at both ends of the dome switch into the locking grooves to fix the dome switch to the board (S210).

As described above, since the dome switch 520 of the present invention is securely fixed to the circuit board 600 through a structure in which the locking projections 522 are inserted into the locking grooves 521, even if a degree of fatigue of the dome switch 520 increases due to long term use thereof, it is possible to prevent deformation of the dome switch 520, thereby increasing the reliability of products.

As can be seen from the foregoing, since a dome switch in accordance with the present invention is directly fixed to a circuit board, even if a degree of fatigue of the dome switch increases due to long term use thereof, it is possible to prevent deformation of the dome switch, thereby increasing the reliability of products.

Although a few embodiments of the present invention have been shown and described, it will be appreciated by those skilled in the art that changes may be made in these embodiments without departing from the principles and spirit of the invention, the scope of which is defined in the appended claims and their equivalents.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A dome switch comprising:
soldering pads formed at an upper surface of a circuit board and spaced a certain distance from one another; and
a dome switch fixed to the soldering pads at two ends of the dome switch.

2. The dome switch according to claim 1, wherein each of the soldering pads has an “I” shape.

3. The dome switch according to claim 1, wherein each of the soldering pads has a “T” shape.

4. The dome switch according to claim 1, wherein the soldering pads include four pads disposed on the upper surface of the circuit board to be opposite to one another in lateral and longitudinal directions.

5. The dome switch according to claim 4, wherein the soldering pads disposed in the lateral and longitudinal directions are integrally formed with one another.

6. A dome switch comprising:
locking grooves formed at an upper surface of a circuit board and spaced a certain distance from one another; and
a dome switch having locking projections formed at two ends of the dome switch with the locking projections inserted into the locking grooves.

7. A method of manufacturing a dome switch comprising:
soldering a contact of a circuit board to form soldering pads;
mounting a dome switch on the circuit board; and
applying heat to the dome switch to fix two ends of the dome switch to the soldering pads.

8. The method according to claim 7, wherein the soldering pads use a solder mask.

9. A method of manufacturing a dome switch comprising:
forming locking grooves at an upper surface of a circuit board; and
inserting locking projections formed at two ends of the dome switch into the locking grooves to fix the dome switch to the circuit board.

10. A keypad assembly comprising:
a lower case;
a circuit board disposed on the lower case;
soldering pads formed at an upper surface of the circuit board and spaced a certain distance from one another;
a dome switch fixed to the soldering pads by soldering two ends of the dome switch;
a key plate installed on the dome switch; and
an upper case coupled to the lower case.

11. A keypad assembly comprising:
a lower case;
a circuit board disposed on the lower case;
locking grooves formed at an upper surface of the circuit board and spaced a certain distance from one another;
a dome switch having locking projections formed at two ends of the dome switch with the locking projections inserted into the locking grooves;
a key plate installed on the dome switch; and
an upper case coupled to the lower case.
